(19) United States
(12) Patent Application Publication
(10) Pub. No.: US 2026/0362559 A1
(43) Pub. Date: Nov. 12, 2026

(54) INDUCTION HEATED ROLL APPARATUS

(71) Applicant: TOKUDEN CO., LTD., Kyoto-shi (JP)

(72) Inventor: Takatsugu KITANO, Otsu-shi (JP)

(21) Appl. No.: 19/356,837

(22) Filed: Oct. 13, 2025

(30) Foreign Application Priority Data
May 8, 2025 (JP) 2025-077801

(51) Int. Cl. H05B 6/14

(52) U.S. Cl. CPC H05B 6/145

(57) ABSTRACT

A roll body includes: a shell with a cylindrical shape; and a pair of journals, respectively provided to each axial end of the shell, which each include: a fitting portion with a cylindrical shape which is fitted with an inner circumferential surface of the axial end of the shell; an end plate with an annular shape which is coupled to an open end face of the axial end of the shell; and a drive shaft with a cylindrical shape which extends axially outward from the end plate. The fitting portion extends axially further inward than an axial end of the induction coil. The shell has first jacket chambers where a heating medium is sealed, formed along an axial direction in thickness of the shell. The fitting portion has second jacket chambers where the heating medium is sealed, formed along the axial direction in thickness of the fitting portion.

### CROSS-REFERENCE TO RELATED APPLICATION(S)

The present application claims priority to Japanese Patent Application No. 2025-077801 filed May 8, 2025, which is incorporated herein by reference in its entirety.

### TECHNICAL FIELD

The present disclosure relates to an induction heated roll apparatus.

### BACKGROUND ART

In a continuous thermal treatment of a continuous material, such as a sheet material or a web material, examples of which include a plastic film, paper, cloth, nonwoven fabric, synthetic fiber, or metal foil, or a linear (fibrous) material, for example, an induction heated roll apparatus including an induction heating mechanism disposed inside a rotating roll body and configured to heat the circumferential surface of the roll body with the heat resulting from induced current is used.

A known induction heated roll apparatus, as described in JP H2-31999 Y, is one including auxiliary induction coils disposed in a manner facing end plates, respectively, that are fitted into the respective ends of the roll body. In such an induction heated roll apparatus, temperature drops at the respective ends of the roll body are suppressed by inductively heating the end plates with the auxiliary induction coils. With this, a more favorable and stable temperature distribution is achieved immediately upon completion of raising the roll temperature.

### REFERENCE DOCUMENT

JP H2-31999 Y

### SUMMARY

However, there is a limitation in improving how quickly the surface temperature distribution of the roll body can be stabilized solely from causing the end plates fitted in the respective ends of the roll body to inductively generate heat.

Therefore, the present disclosure has been made to address the issue described above, and a main object of the present disclosure is to stabilize the axial surface temperature distribution of a shell on a roll body even more quickly.

That is, an induction heated roll apparatus according to the present disclosure includes: a roll body that is hollow and that is rotatably supported; and an induction heating mechanism that is disposed inside the hollow and that includes an induction coil, in which the roll body includes: a shell that has a cylindrical shape; and a pair of journals that are respectively provided to each axial end of the shell, in which each journal includes: a fitting portion that has a cylindrical shape and that is fitted with an inner circumferential surface of the axial end of the shell; an end plate that has an annular shape and that is coupled to an open end face of the axial end of the shell; and a drive shaft that has a cylindrical shape and that extends axially outward from the end plate, in which each fitting portion extends axially further inward than an axial end of the induction coil, in which the shell has at least one first jacket chamber where a heating medium is sealed, the at least one first jacket chamber being formed along an axial direction in thickness of the shell, and in which each fitting portion has at least one second jacket chamber where the heating medium is sealed, the at least one second jacket chamber being formed along the axial direction in thickness of the fitting portion.

In the induction heated roll apparatus according to the present disclosure, the fitting portion of each journal extends axially further inward than the axial end of the induction coil, and the fitting portion has the at least one second jacket chamber formed along the axial direction in the thickness of the fitting portion. Therefore, the fitting portion is inductively heated by the induction coil, and the axial temperature of the fitting portion can be stabilized quickly. As a result, temperature drops at the axial ends of the shell can be suppressed, and the axial surface temperature distribution of the shell can be stabilized more quickly.

Furthermore, because the shell has the at least one first jacket chamber formed along the axial direction in the thickness of the shell, also with the effect of the configuration in which the fitting portion is provided with the at least one second jacket chamber, the axial surface temperature of the shell on the roll body can be stabilized quickly.

Furthermore, by suppressing temperature drops at the axial ends of the shell, it is not necessary to extend ineffective lengthwise portions provided on the axial ends of the shell, so that it is possible to increase the effective lengthwise portion coming into contact with an object to be heated on the shell (to reduce the ineffective lengthwise portion).

In addition, by suppressing temperature drops at the axial ends of the shell, it is possible to prevent the axial ends of the shell from becoming smaller in diameter than the axial center.

Preferably, for each fitting portion, the at least one second jacket chamber extends axially further inward than an axial end of the at least one first jacket chamber.

With this configuration, because it is possible to ensure an area where the at least one first jacket chamber and the at least one second jacket chamber overlap each other in the axial direction so as to allow the heat transferred from the at least one first jacket chamber and the heat transferred from the at least one second jacket chamber to affect each other, the temperatures of the shell and the two fitting portions can be equalized. As a result, the axial surface temperature of the shell on the roll body can be stabilized quickly.

Preferably, for each journal, the end plate has at least one third jacket chamber where the heating medium is sealed, the at least one third jacket chamber being formed along a radial direction in thickness of the end plate.

The end plate of each journal is heated by the heat transferred from the fitting portion. Because the end plate is provided with the at least one third jacket chamber extending in the radial direction, thermal energy resulting from the fitting portion becoming inductively heated quickly spreads across the fitting portion and the end plate. As a result, the temperature drops at the axial ends of the shell can be suppressed, and the axial surface temperature distribution of the shell on the roll body can be stabilized quickly. Furthermore, because the fitting portion and the end plate are allowed to thermally expand in the same manner as the shell, the end plate can be prevented from becoming a restraining body restraining the shell. As a result, it is possible to prevent the precise circular shape of the shell from deteriorating, and to prevent excessive stress from being exerted on, and damaging, the end plate.

Preferably, for each drive shaft, the drive shaft has at least one fourth jacket chamber where the heating medium is sealed, the at least one fourth jacket chamber being formed along the axial direction in thickness of the drive shaft.

For each journal, the drive shaft is heated by the heat transferred from the fitting portion and the end plate. Because the drive shaft has the at least one fourth jacket chamber provided along the axial direction, the thermal energy resulting from the fitting portion becoming inductively heated quickly spreads to the fitting portion, the end plate, and the drive shaft. As a result, the temperature drops at the axial ends of the shell can be suppressed, and the axial surface temperature distribution of the shell on the roll body can be stabilized quickly. Furthermore, the fitting portion, the end plate, and the drive shaft are allowed to thermally expand in the same manner as the shell, the end plate and the drive shaft can be prevented from becoming a restraining body restraining the shell. As a result, it is possible to prevent the precise circular shape of the shell from deteriorating, and to prevent excessive stress from being exerted on, and damaging, the end plate and the drive shaft.

Preferably, for each journal, an annular groove-shaped fitting recess into which the fitting portion is fitted is formed on the inner circumferential surface of the axial end of the shell. In a state in which the fitting portion is fitted in the fitting recess, the inner circumferential surface of the fitting portion and the inner circumferential surface of the shell are preferably substantially on the same plane. Note that the induction coil preferably has a constant outer diameter across one axial end to the other axial end.

With this configuration, even with the fitting portion extending axially further inward than the axial end of the induction coil, it is possible to keep the distance between the outer circumferential surface of the induction coil and the inner circumferential surface of the shell short. As a result, better magnetic coupling can be achieved, and the shell can be heated at a high power factor.

Preferably, the induction coil is split in the axial direction, and includes a shell induction coil that inductively heats the shell, and a pair of fitting portion induction coils that respectively inductively heat the fitting portion of each journal.

With this configuration, induction heating of the shell and induction heating of the fitting portions can be controlled individually. By individually controlling the induction heating of the fitting portion, the effect of heating the fitting portions (the effect of suppressing temperature drops at the axial ends of the shell) can be maximized.

The induction heated roll apparatus according to the present disclosure preferably includes: a temperature sensor that detects a temperature of at least one of the journals; and a control device that controls power supply to the fitting portion induction coil based on the temperature detected by the temperature sensor.

With this configuration, the temperature of the journal(s) can be controlled to an intended temperature, so that the surface temperature of the shell on the roll body in the axial direction can be quickly stabilized.

According to the present disclosure configured as described above, the surface temperature of the shell on the roll body in the axial direction can be stabilized quickly.

### BRIEF DESCRIPTION OF THE DRAWINGS

FIG. 1 is a cross-sectional view schematically illustrating a configuration of an induction heated roll apparatus according to an embodiment of the present disclosure;

FIG. 2 is a partially enlarged cross-sectional view of a characterizing portion of the embodiment;

FIG. 3 is a cross-sectional view schematically illustrating a configuration of the induction heated roll apparatus according to a modification;

FIG. 4 is a cross-sectional view schematically illustrating a configuration of the induction heated roll apparatus according to a modification; and

FIG. 5 is a cross-sectional view schematically illustrating a configuration of the induction heated roll apparatus according to a modification.

### DETAILED DESCRIPTION

An induction heated roll apparatus according to one embodiment of the present disclosure will now be explained with reference to some drawings. Note that all of the drawings described below are schematic representations, with some omissions and exaggerations made as appropriate, to facilitate understanding. The same elements are denoted by the same reference characters, and the descriptions thereof will be omitted as appropriate.

### Configuration of Apparatus

An induction heated roll apparatus 100 according to this embodiment is used in a continuous thermal treatment of a continuous material, such as a sheet material or a web material, examples of which include a plastic film, paper, cloth, nonwoven fabric, synthetic fiber, or metal foil, or a linear (fibrous) material.

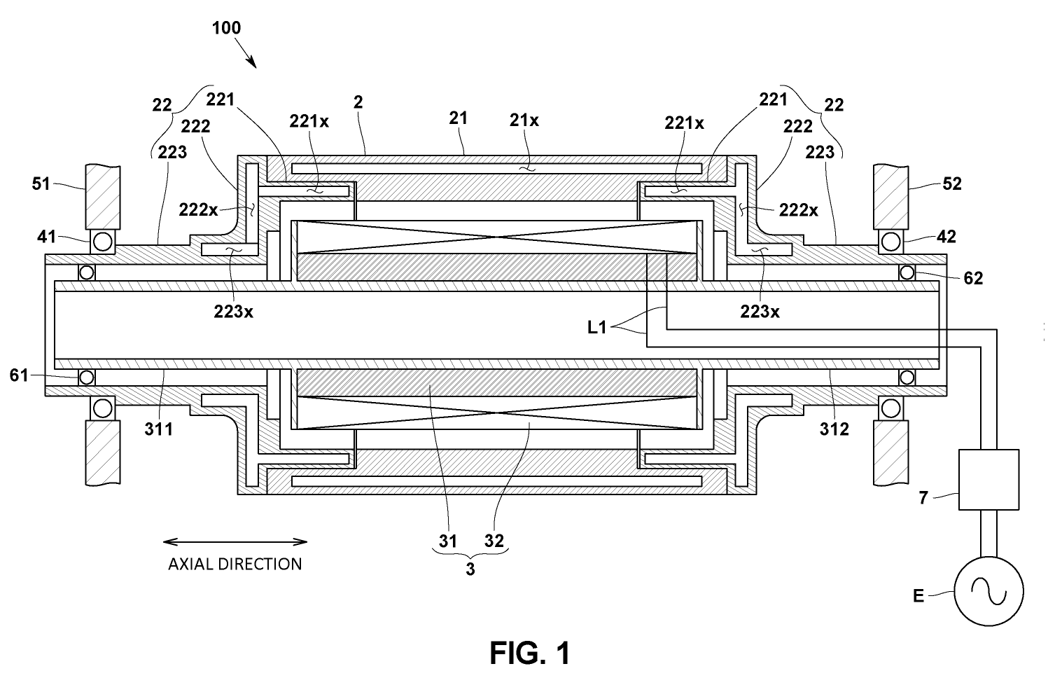

Specifically, as illustrated in FIG. 1, the induction heated roll apparatus 100 includes a cylindrical roll body 2 that is hollow and supported rotatably, and an induction heating mechanism 3 disposed stationarily inside the hollow in the roll body 2.

The roll body 2 has a shell 21 that has a cylindrical shape, and journals 22 that are provided to the respective axial ends of the shell 21.

Each of the journals 22 includes a fitting portion 221 that has a cylindrical shape and that is fitted with the inner circumferential surface of an axial end of the shell 21, an end plate 222 that has an annular shape and that is coupled to an open end face of the axial end of the shell 21 with a fastening bolt (not illustrated), and a drive shaft 223 that has a cylindrical shape and that extends axially outward from the end plate 222. The drive shaft 223 is rotatably supported by bases 51, 52 with respective bearings 41, 42, such as rolling bearings, disposed therebetween. The roll body 2 is configured to be rotated by an external driving force, e.g., by a rotation driving mechanism (not illustrated) such as a motor.

The shell 21 on the roll body 2 is provided with at least one first jacket chamber 21x where a gas-liquid two-phase heating medium is sealed, along a longitudinal direction (hereinafter referred to as an axial direction). Hereinafter, description will be made to embodiments in which the shell 21 has a plurality of first jacket chambers 21x that are provided at some intervals, e.g., at equal intervals, along the entire circumferential direction of the shell 21. With the latent heat transfer of this gas-liquid two-phase heating medium sealed in the first jacket chambers 21x, the axial surface temperature of the shell 21 is equalized.

The induction heating mechanism 3 includes a cylindrical iron core 31 having a cylindrical shape, an induction coil 32 wound around the outer circumferential surface of the cylindrical iron core 31, and support shafts 311, 312 supporting the cylindrical iron core 31 and the induction coil 32. The support shafts 311, 312 are provided to the respective ends of the cylindrical iron core 31. The support shafts 311, 312 are inserted into the respective drive shafts 223, and are supported rotatably by the respective drive shafts 223, with bearings 61, 62, such as rolling bearings, interposed therebetween, respectively. In this manner, the induction heating mechanism 3 is held inside the rotating roll body 2 stationarily with respect to the fixed sides (bases 51, 52). To the induction coil 32, a lead wire L1 is connected, and an alternating-current power source E for applying alternating-current voltage is connected to the lead wire L1, with a power adjustment device 7 inserted therebetween. The power adjustment device 7 is controlled by a control device (not illustrated) to bring the temperature of the roll body 2 to an intended temperature.

With such an induction heating mechanism 3, when the alternating-current voltage is applied to the induction coil 32, an alternating magnetic flux is formed, and the alternating magnetic flux passes through the shell 21 of the roll body 2. With this passage, induction current is generated in the shell 21, and the shell 21 is Joule-heated by the induction current.

### Characterizing Configuration of Roll Body 2

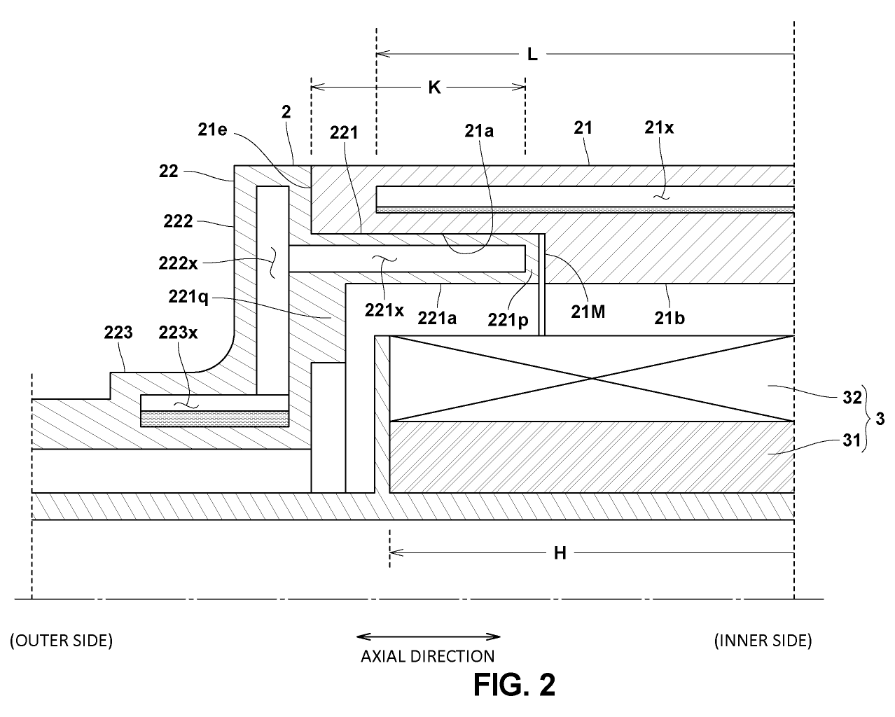

A characterizing configuration of the roll body 2 will now be explained with reference to FIGS. 1 and 2. FIG. 2 is a partially enlarged view of the left end of the roll body 2 in the axial direction. Although explained hereunder is a configuration of the left end in the axial direction, the right end in the axial direction also has the same configuration.

As illustrated in FIGS. 1 and 2, the fitting portion 221 of each journal 22 extends further inward than the axial end of the induction coil 32 in the axial direction. In other words, as illustrated in FIG. 2, the fitting portion 221 has a tip end 221p at a position within a formation range H, in the axial direction of the induction coil 32.

Here, as illustrated in FIG. 2, for each journal 22, an annular groove-shaped fitting recess 21M into which the fitting portion 221 is fitted is formed on the inner circumferential surface of the axial end of the shell 21. With such a configuration for fitting the fitting portion 221 with the fitting recess 21M in the manner described above, the shell 21 has a structure in which a part on the inner side of the fitting portions 221 in the axial direction protrudes further radially inward, than the fitting surface 21a with which the fitting portion 221 is fitted.

Each fitting recess 21M according to the embodiment has a depth, in the radial direction, substantially the same as the thickness of the tip end 221p of the respective fitting portion 221, and, by fitting the fitting portion 221 with the fitting recess 21M, the inner circumferential surface 221a of the tip end 221p of the fitting portion 221 is brought to the same plane or substantially the same plane as an inner circumferential surface 21b of the shell 21, the inner circumferential surface 21b being a surface on a further inward side than the fitting recess 21M. In other words, the inner circumferential surface 221a of the tip end 221p and the inner circumferential surface 21b of the shell 21 have the same or substantially the same diameters. With this configuration, even with the fitting portion 221 extending axially further inward than the axial end of the induction coil 32, it is possible to keep the distance between the outer circumferential surface of the induction coil 32 and the inner circumferential surface 21b of the shell 21 short. As a result, better magnetic coupling can be achieved, and the shell 21 can be heated at a higher power factor.

As illustrated in FIGS. 1 and 2, the fitting portion 221 of each journal 22 is provided on the inner surface of the end plate 222 in the axial direction. As illustrated in FIG. 2, a base end 221q of the fitting portion 221 is thicker on the radially inner side, than the tip end 221p. With this, the mechanical strength of the fitting portion 221 with the fitting portion 221 fitted with the shell 21 is ensured, even in a structure in which the fitting portion 221 is provided with at least one second jacket chamber 221x. With the fitting portion 221 fitted into the shell 21, the end plate 222 is coupled to the open end face 21e of an axial end of the shell 21, with a fastening bolt (not illustrated).

The induction coil 32 according to the embodiment has a constant outer diameter across one end in the axial direction to the other end in the axial direction. Therefore, the distance between the outer circumferential surface of the induction coil 32 and the inner circumferential surface 221a of the fitting portion 221 is the same or substantially the same as the distance between the outer circumferential surface of the induction coil 32 and the inner circumferential surface 21b of the shell 21.

As illustrated in FIGS. 1 and 2, the at least one second jacket chamber 221x where a gas-liquid two-phase heating medium is sealed is formed along the axial direction in the thickness of the fitting portion 221 of each journal 22. Hereinafter, description will be made to embodiments in which the fitting portion 221 has a plurality of second jacket chambers 221x that are provided, for example, at equal intervals, along the entire circumferential direction. With the latent heat transfer of this gas-liquid two-phase heating medium sealed in the second jacket chambers 221x, the temperature of the fitting portion 221 in the axial direction is equalized.

The second jacket chambers 221x extend further inward, in the axial direction, than the axial ends of the first jacket chambers 21x formed inside the shell 21. In other words, as illustrated in FIG. 2, a range L where the first jacket chambers 21x are formed in the shell 21 along the axial direction overlaps, in the axial direction, with a formation range K where the second jacket chambers 221x are formed in the fitting portion 221 of each journal 22 along the axial direction.

Furthermore, as illustrated in FIGS. 1 and 2, at least one third jacket chamber 222x where a gas-liquid two-phase heating medium is sealed is formed along the radial direction in the thickness of the end plate 222 of each journal 22. Hereinafter, description will be made to embodiments wherein a plurality of third jacket chambers 222x are radially formed in the end plate 222, across the entire circumferential direction, with intervals therebetween, for example. With the latent heat transfer of this gas-liquid two-phase heating medium sealed in the third jacket chambers 222x, the temperature of the end plate 222 in the radial direction is equalized. The third jacket chambers 222x according to the embodiment are in communication with the second jacket chambers 221x so that the heating medium can move back and forth between the jacket chambers 221x, 222x. The third jacket chambers 222x may also be independent chambers that are separated from the second jacket chambers 221x.

In addition, as illustrated in FIGS. 1 and 2, at least one fourth jacket chamber 223x where a gas-liquid two-phase heating medium is sealed is formed along the axial direction in the thickness of the drive shaft 223 of each journal 22. Hereinafter, description will be made to embodiments in which the drive shaft 223 has a plurality of fourth jacket chambers 223x that are provided at some intervals, e.g., at equal intervals, along the entire circumferential direction. With the latent heat transfer of this gas-liquid two-phase heating medium sealed in the fourth jacket chambers 223x, the temperature of the drive shaft 223 in the axial direction is equalized. The fourth jacket chambers 223x according to the embodiment are in communication with the third jacket chambers 222x so that the heating medium can move back and forth between the jacket chambers 222x, 223x. The fourth jacket chambers 223x may also be independent chambers that are separated from the third jacket chambers 222x.

In such a configuration, when the induction heating mechanism 3 applies alternating-current voltage to the induction coil 32, an alternating magnetic flux is generated, and the alternating magnetic flux passes through the fitting portions 221 of the journals 22. With this passage, induced current is generated in the fitting portions 221, and the fitting portions 221 are Joule-heated by the induced current. The thermal energy generated in the fitting portions 221 spreads along the second jacket chambers 221x to the entire fitting portions 221; the thermal energy transferred from the fitting portions 221 to the end plates 222 spreads along the third jacket chambers 222x to the entire end plates 222; and the thermal energy transferred from the end plates 222 to the drive shaft 223 spreads along the fourth jacket chambers 223x to the entire drive shaft 223.

### Advantageous Effects Achieved by Embodiment

With the induction heated roll apparatus 100 configured as described above, because the fitting portions 221 of the respective journals 22 extend axially further inward than the axial ends of the induction coil 32, and the second jacket chambers 221x are formed along the axial direction in the thickness of each of the fitting portions 221, the fitting portions 221 are inductively heated by the induction coil 32, so that the axial temperatures of the fitting portions 221 can be stabilized quickly. As a result, temperature drops at the respective axial end of the shell 21 can be suppressed, so that the axial surface temperature distribution of the shell 21 can be stabilized even more quickly.

Furthermore, the first jacket chambers 21x are formed along the axial direction in the thickness of the shell 21, so that the axial surface temperature of the shell 21 on the roll body 2 can be quickly stabilized, also with the effect of the configuration in which the fitting portions 221 are provided with the second jacket chambers 221x.

Furthermore, by suppressing temperature drops at the axial ends of the shell 21, it is not necessary to extend ineffective lengthwise portions provided on the axial ends of the shell 21, so that it is possible to extend the effective lengthwise portion coming into contact with an object to be heated on the shell 21 (to shorten the ineffective lengthwise portion).

In addition, by suppressing temperature drops at the axial ends of the shell 21, it is possible to prevent the axial ends of the shell 21 from becoming smaller in diameter than the axial center.

### Other Modifications

Note that the present disclosure is not limited to the embodiment described above.

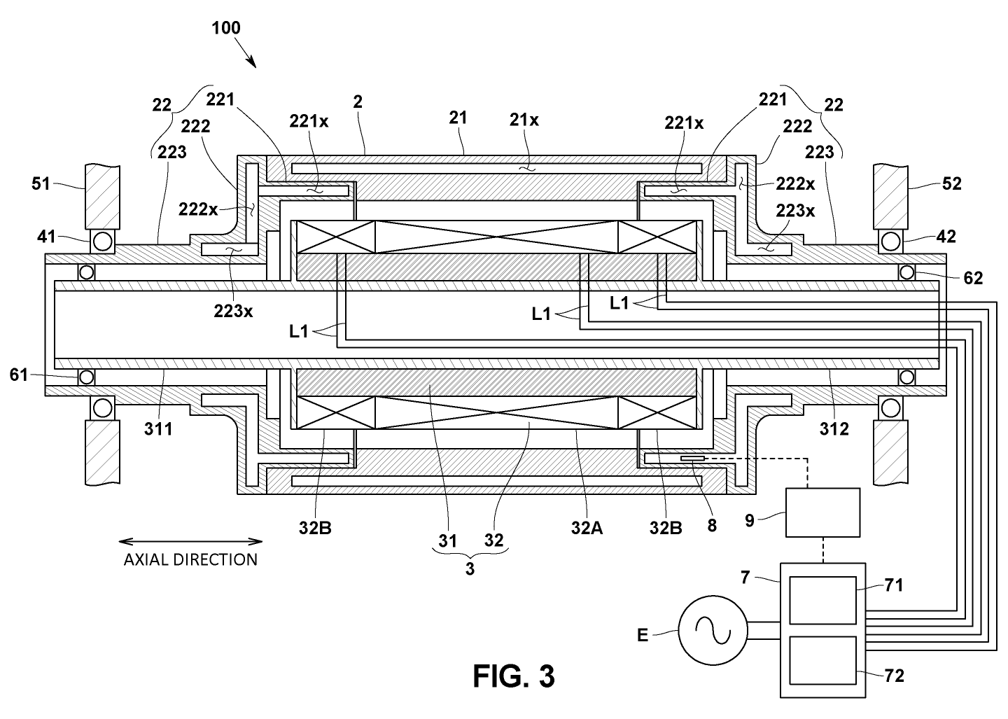

For example, as illustrated in FIG. 3, the induction coil 32 may be split in the axial direction, and include a shell induction coil 32A for inductively heating the shell 21, and fitting portion induction coils 32B for inductively heating the respective fitting portions 221. With this configuration, induction heating of the shell 21 and induction heating of the fitting portions 221 can be controlled individually. By individually controlling the induction heating of the fitting portions 221, the effect of heating the fitting portions 221 (the effect of suppressing temperature drops at the axial ends of the shell 21) can be maximized.

The shell induction coil 32A and the fitting portion induction coils 32B may have the same or substantially the same outer diameters. Furthermore, the axial centers of the respective fitting portion induction coils 32B may be positioned on outer sides of the tip end 221p of the fitting portion 221, respectively, in the axial direction. With this configuration, heat-generating energy of the fitting portion induction coils 32B can be effectively used for heating the fitting portions 221.

Furthermore, the induction heated roll apparatus 100 may include a temperature sensor 8 that detects the temperature of at least one of the journals 22, and a control device 9 that controls the power supply to the fitting portion induction coil 32B based on the temperature detected by the temperature sensor 8. The temperature sensor 8 illustrated in FIG. 3 is provided in one of the second jacket chambers 221x, but may also be provided to a part other than the second jacket chambers 221x, as long as the temperature of the at least one journal 22 is detected. The control device 9 controls a power adjustment device 72 that controls the power supply to the fitting portion induction coils 32B by adjusting the power supplied to the fitting portion induction coils 32B. Note that reference character 71 denotes a power adjustment device that adjusts the power supplied to the shell induction coil 32A, and the power adjustment device is controlled by the control device 9. With this configuration, the journals 22 can be controlled to an intended temperature, so that the axial surface temperature of the shell 21 on the roll body 2 can be stabilized quickly.

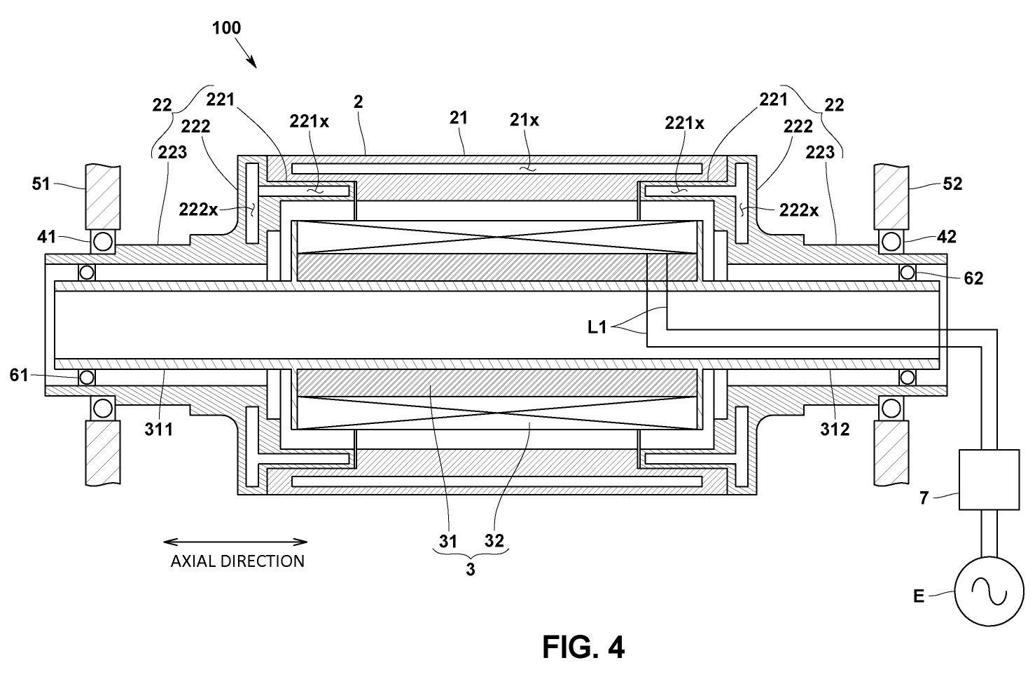

In the embodiment described above, the journals 22 each have a configuration including the second jacket chambers 221x, the third jacket chambers 222x, and the fourth jacket chambers 223x. However, as illustrated in FIG. 4, the journals 22 may each have a configuration including at least the jacket chambers 221x, and may have a configuration not including at least one of the third jacket chambers 222x or the fourth jacket chambers 223x. FIG. 4 illustrates a configuration without the fourth jacket chambers 223x.

In the embodiment described above, the inner circumferential surface 221a of the tip end 221p of the fitting portion 221 is on the same plane or on substantially the same plane as the inner circumferential surface 21b of the shell 21. However, the inner circumferential surface 21b of the shell 21 may be positioned on a further outward side than the inner circumferential surface 221a of the fitting portion 221 in the radial direction, or a further inward side in the radial direction.

In the embodiment described above, the second jacket chambers 221x extend axially further inward than the axial ends of the first jacket chambers 21x, but it is also possible for the second jacket chambers 221x not to extend axially further inward than the axial ends of the first jacket chambers 21x.

Furthermore, at least one of the first jacket chambers 21x, the second jacket chambers 221x, the third jacket chambers 222x, or the fourth jacket chambers 223x may be in communication in the circumferential direction. With this communication in the circumferential direction, the temperature can be equalized not only in the axial direction but also in the circumferential direction.

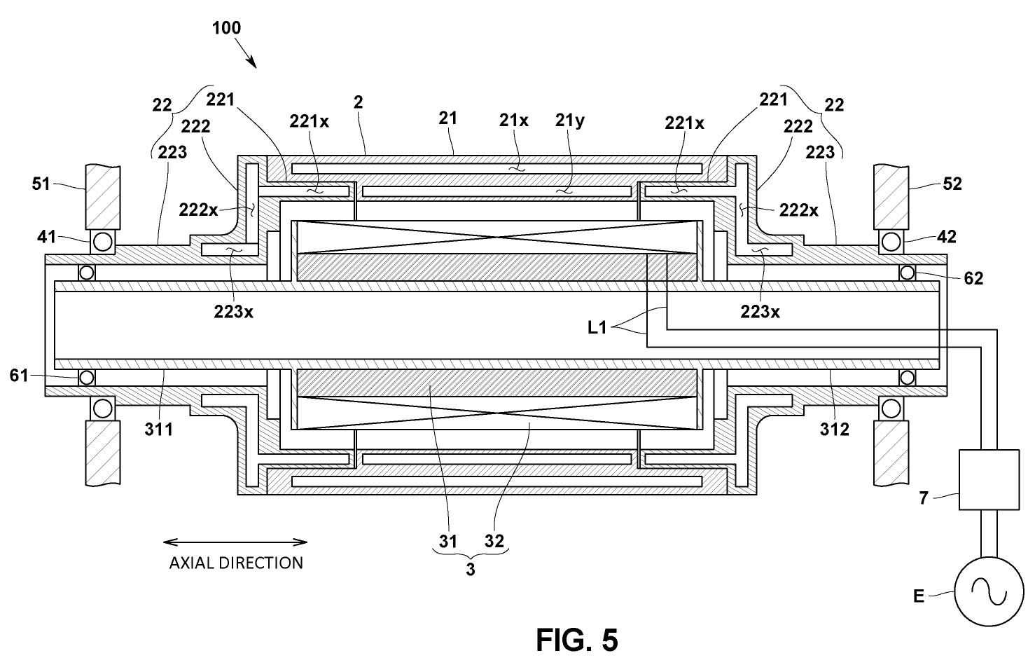

Furthermore, as illustrated in FIG. 5, a first jacket chamber 21y where the gas-liquid two-phase heating medium is sealed may be provided along the axial direction in the thick portion of the shell 21, the thick portion being positioned on a further inward side than the fitting portions 221 in the axial direction (the part protruding more radially inward than the fitting surface 21a). With the latent heat transfer of this gas-liquid two-phase heating medium sealed in the first jacket chambers 21y, the temperature of the thick portion in the axial direction is equalized. It is also possible to provide only the first jacket chambers 21y, instead of providing both of the first jacket chambers 21x and the first jacket chambers 21y.

In addition, the present disclosure is not limited to the embodiment described above, and it should be needless to say that various modifications may be made within the scope not departing from the gist of the present disclosure.

### REFERENCE CHARACTER LIST

100 induction heated roll apparatus
2 roll body
21 shell
22 journal
221 fitting portion
222 end plate
223 drive shaft
21x first jacket chamber
221x second jacket chamber
222x third jacket chamber
223x fourth jacket chamber
21M fitting recess
32A shell induction coil
32B fitting portion induction coil
8 temperature sensor
9 control device

What is claimed is:

1. An induction heated roll apparatus, comprising:
a roll body that is hollow and that is rotatably supported; and
an induction heating mechanism that is disposed inside the hollow and that includes an induction coil,
wherein the roll body includes:
a shell that has a cylindrical shape; and
a pair of journals that are respectively provided to each axial end of the shell,
wherein each journal includes:
a fitting portion that has a cylindrical shape and that is fitted with an inner circumferential surface of the axial end of the shell;
an end plate that has an annular shape and that is coupled to an open end face of the axial end of the shell; and
a drive shaft that has a cylindrical shape and that extends axially outward from the end plate,
wherein each fitting portion extends axially further inward than an axial end of the induction coil,
wherein the shell has at least one first jacket chamber where a heating medium is sealed, the at least one first jacket chamber being formed along an axial direction in thickness of the shell, and
wherein each fitting portion has at least one second jacket chamber where the heating medium is sealed, the at least one second jacket chamber being formed along the axial direction in thickness of the fitting portion.

2. The induction heated roll apparatus according to claim 1, wherein for each fitting portion, the at least one second jacket chamber extends axially further inward than an axial end of the at least one first jacket chamber.

3. The induction heated roll apparatus according to claim 1, wherein for each journal, the end plate has at least one third jacket chamber where the heating medium is sealed, the at least one third jacket chamber being formed along a radial direction in thickness of the end plate.

4. The induction heated roll apparatus according to claim 3, wherein for each journal, the drive shaft has at least one fourth jacket chamber where the heating medium is sealed, the at least one fourth jacket chamber being formed along the axial direction in thickness of the drive shaft.

5. The induction heated roll apparatus according to claim 1, wherein for each journal, an annular groove-shaped fitting recess into which the fitting portion is fitted is formed on the inner circumferential surface of the axial end of the shell.

6. The induction heated roll apparatus according to claim 1, wherein the induction coil is split in the axial direction, and includes a shell induction coil that inductively heats the shell, and a pair of fitting portion induction coils that respectively inductively heat the fitting portion of each journal.

7. The induction heated roll apparatus according to claim 6, further comprising:
a temperature sensor that detects a temperature of at least one of the journals; and
a control device that controls power supply to the fitting portion induction coil based on the temperature detected by the temperature sensor.
